(19) United States
(12) Patent Application Publication
(10) Pub. No.: US 2017/0227688 A1
(43) Pub. Date: Aug. 10, 2017

(54) SHAPED ARTICLE

(71) Applicant: Takayuki OTA, Fukuoka-shi (JP)

(72) Inventor: Takayuki OTA, Fukuoka-shi (JP)

(21) Appl. No.: 15/451,407

(22) Filed: Mar. 7, 2017

Related U.S. Application Data
(63) Continuation of application No. PCT/JP2015/075455, filed on Sep. 8, 2015.

(30) Foreign Application Priority Data
Sep. 8, 2014 (JP) 2014-181838

(51) Int. Cl. G02B 5/02; A44C 17/00

(52) U.S. Cl. CPC G02B 5/0284; G02B 5/0221; A44C 17/00

(57) ABSTRACT

Shaped articles 42, 43 are inseparably and integrally formed of a colorless transparent material or a colored transparent material, and a peripheral surface has an uneven shape. In the shaped article 42 formed by a flat and irregular polyhedron and the article 43 formed by a plurality of recesses 44 shaped by burning, the entered light is refracted and reflected in various directions and radiated outside the shaped articles to be seen by a viewer. In the shaped article 43, a housed object 45 is visually complemented by the shadowed part of the recesses 44. Thus, the light is seen by the viewer. The visual effect of making the front surface shine brightly can be kept by dispersing and reflecting incident light. In addition, a risk of bodily injury and environmental disaster caused by light concentration can be avoided by suppressing transmission light irradiated from the irregular polyhedron and the recesses 44.

### CROSS-REFERENCES TO RELATED APPLICATIONS

This Application claims the benefit of priority and is a Continuation application of the prior International Patent Application No. PCT/JP2015/075455, with an international filing date of Sep. 8, 2015, which designated the United States, and is related to the Japanese Patent Application No. 2014-181838, filed Sep. 8, 2014, the entire disclosures of all applications are expressly incorporated by reference in their entirety herein.

### BACKGROUND OF THE INVENTION

1. Field of the Invention

The present invention relates to a shaped article formed of a colorless transparent material or a colored transparent material.

2. Description of Related Art

The shaped article formed of the colorless transparent material or the colored transparent material has a visual effect to attract a viewer's interest because of brightness arising from its transparency. As a material of the above described shaped article, a glass, a plastic, precious stones and jewels are exemplified. These are used for an accessory, an ornament, a toy, a decorative object and a chandelier by themselves.

For example, in a jewel toy of Patent document 1 shown in FIG. 6, the front surface of a transparent imitation jewel body 1 is processed into a jewel shape and a mirror sticker 2 reflecting light is adhered on the reverse surface. Thus, the light entering from the front surface of the imitation jewel body 1 is reflected and dispersed by the mirror sticker 2 to make the surface shape of the imitation jewel body 1 shine brightly.

[Patent document 1] Japanese Utility Model Registration No. 3008638 (abstract, paragraph [0015], FIG. 1)

### BRIEF SUMMARY OF THE INVENTION

However, in the above described jewel toy, the reverse surface itself of the imitation jewel body 1 does not have to be directly processed (paragraph [0022] of Patent document 1). Hence, the mirror sticker 2 is necessary for reflecting the light entering from the front surface of the imitation jewel body 1. There is a problem that the number of components is increased.

On the other hand, when the glass material, the precious stones or the jewels themselves are used as the shaped article for the accessary, transmission light entering in the shaped article and transmitting from the shaped article may seriously influence the human body and the surrounding environment. For example, when the shaped article is worn as an accessory such as a necklace and a pendant, there is a problem to cause bodily injury such as sunburn and burn injury if the human body is exposed to the transmission light. In addition, when the shaped article is used as a decorative object or an ornament, there is a problem to cause disasters such as smoking and ignition if the surrounding object is exposed to the transmission light. The influence of the above described problems is particularly remarkable when the transmission light is focused on a focal point by a lens effect.

The present invention provides a shaped article with the small number of components while avoiding the risk of the bodily injury and the environmental disaster, and keeping the visual effect caused by forming the shaped article by the colorless transparent material or the colored transparent material.

The shaped article of the present invention is inseparably and integrally formed of a colorless transparent material or a colored transparent material, and a peripheral surface of the shaped article has an uneven shape.

More specifically, the present invention provides the following configurations.

(1) A shaped article inseparably and integrally formed of a colorless transparent material or a colored transparent material, wherein a peripheral surface of the shaped article has an uneven shape, and the uneven shape is formed by a flat and irregular polyhedron.

By using the present invention, the uneven shape realized by the flat and irregular polyhedron takes incident light in the shaped article by the flat area. In addition, because of the irregular polyhedron, the incident light having various incident angles can be taken in. Furthermore, reflection light having various reflection angles can be generated when the incident light taken in is reflected at the other surfaces. Thus, scattering of the light is encouraged in the shaped article by combining both the incident light and the reflection light. Accordingly, the shaped article itself and an inside of the shaped article are visually complemented to help attracting a viewer's interest.

In other words, the dispersion of the light in the shaped article also leads to the dispersion of radiation light (emission light) radiated to an outside of the shaped article. Accordingly, the light can be prevented from being focused on a specific area. Thus, the risk of the bodily injury and the environmental disaster caused by light concentration can be avoided.

(2) A shaped article inseparably and integrally formed of a colorless transparent material or a colored transparent material, wherein a peripheral surface of the shaped article has an uneven shape, and the uneven shape is formed by a plurality of recesses shaped by burning.

By using the present invention, the uneven shape realized by the plurality of recesses shaped by burning suppresses an amount of the incident light taken in the shaped article, and the incident light taken in the shaped article is dispersed and reflected. Thus, scattering of the light is encouraged in the shaped article. Accordingly, the shaped article itself and an inside of the shaped article are visually complemented to help attracting a viewer's interest.

In other words, the dispersion of the light in the shaped article also leads to the dispersion of radiation light (emission light) radiated to an outside of the shaped article. Accordingly, the light can be prevented from being focused on a specific area. Thus, the risk of the bodily injury and the environmental disaster caused by light concentration can be avoided.

(3) The shaped article, wherein a front surface and a reverse surface are inseparably and integrally formed, a smooth shape is formed on at least the front surface to make light incident, and the uneven shape is formed on at least the reverse surface to disperse and reflect the light.

By using the present invention, the number of components can be reduced since the front surface and the reverse surface are inseparably and integrally formed in the shaped article. In addition, a smooth shape, which is formed to be smooth, is formed on at least the front surface to make light incident. Therefore, the incident light can be easily taken in the shaped article. Furthermore, an uneven shape, which is formed to be uneven, is formed on at least the reverse surface to disperse and reflect the light. Therefore, the visual effect of making the front surface shine brightly relatively can be kept by dispersing and reflecting the incident light. In addition, the transmission light from the reverse surface can be suppressed. Thus, the risk of the bodily injury and the environmental disaster caused by light concentration can be avoided.

(4) The shaped article, wherein a housed object selected from the group consisting of: a noble metal; a precious stone; a jewel; an imitation of the noble metal, the precious stone or the jewel; and a combination of two or more of the noble metal, the precious stone, the jewel and the imitation is housed in the shaped article.

By using the present invention, the brightness of the noble metal (e.g., gold, silver and platinum), the precious stone (gemstone of the jewel), the jewel (gem) and the imitation of them housed in the shaped article can be enjoyed. In particular, the uneven shape, which is formed by the smooth and irregular polyhedron or the plurality of recesses shaped by burning, encourages the scattering of the light in the shaped article. Thus, the scattered light having various angles is applied to the housed object and the housed object can be visually complemented.

In addition, the uneven shape formed by the plurality of recesses shaped by burning suppresses the incidence of the light, and disperses and reflects the light. Thus, the housed object can be visually complemented further more. In the conventional technology, the housed object can be visually complemented by housing a high brightness material such as gold and silver since the light can penetrate through the peripheral surface entirely. In the present invention, the housed object can be visually complemented by the uneven shape formed by the plurality of recesses. Thus, the housed object can be selected regardless of the brightness.

The shaped article of the present invention is inseparably and integrally formed of a colorless transparent material or a colored transparent material, and a peripheral surface of the shaped article has an uneven shape. Because of this, the number of components can be reduced. In addition, scattering of the light is encouraged in the shaped article by the uneven shape. Furthermore, the visual effect of making the front surface, the precious stone or the like shine brightly can be kept by dispersing and reflecting the incident light, and the risk of the bodily injury and the environmental disaster caused by light concentration can be avoided.

### BRIEF DESCRIPTION OF THE DRAWINGS

FIGS. 1A and 1B are diagrams showing a shaped article concerning an embodiment of the present invention.

FIGS. 2A and 2B are diagrams showing another shaped article concerning an embodiment of the present invention.

FIGS. 3A to 3C are diagrams showing an example of a side surface or a peripheral surface of the shaped article.

FIG. 4 is a schematic diagram showing a light path of a shaped article having a regular shape.

FIGS. 5A and 5B are schematic diagrams showing a light path of a shaped article having an irregular shape.

FIG. 6 is a diagram showing an example of a conventional jewel toy.

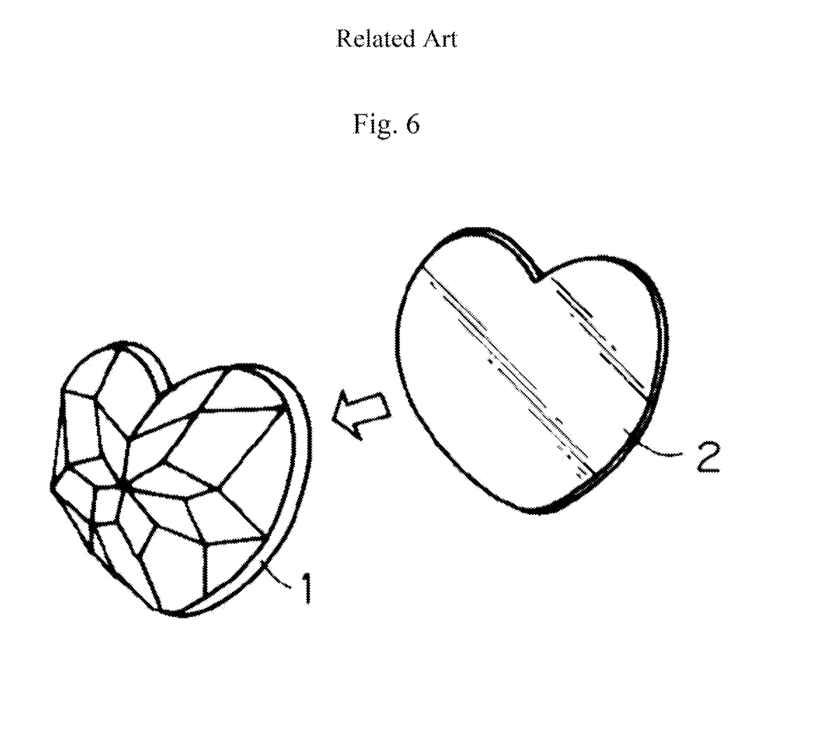

### DETAILED DESCRIPTION OF THE INVENTION

Hereafter, embodiments of the present invention will be explained based on the drawings.

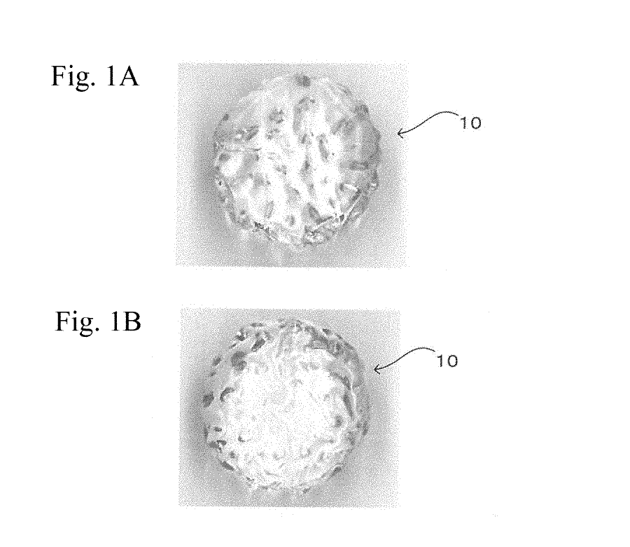

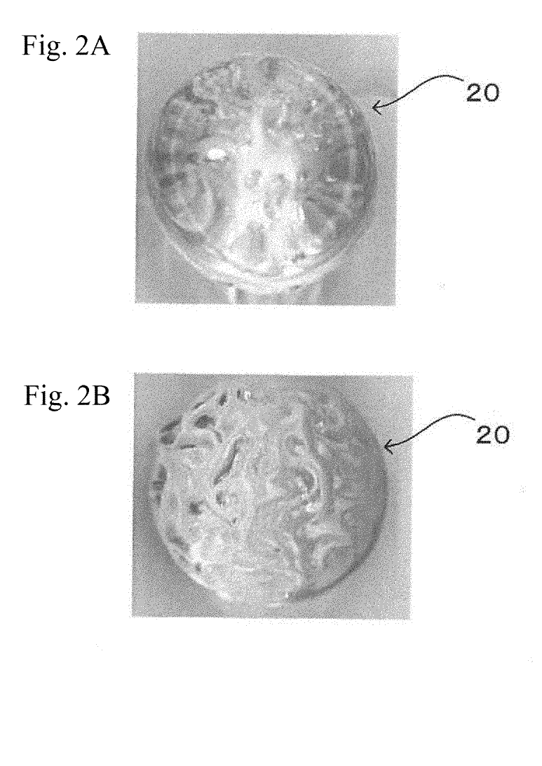

FIGS. 1A and 1B are diagrams showing a shaped article 10 concerning an embodiment of the present invention. FIG. 1A shows a front surface, and FIG. 1B shows a reverse surface. FIGS. 2A and 2B are diagrams showing another shaped article 20 concerning an embodiment of the present invention. FIG. 2A shows a front surface, and FIG. 2B shows a reverse surface. Here, the shaped article 10 shown in FIGS. 1A and 1B has a columnar shape as a whole, and the shaped article 20 shown in FIGS. 2A and 2B has a semi-spherical shape as a whole. Note that the shaped article can be a shaped article 30 having a spherical shape as a whole. Moreover, various shapes such as a spherically agglomerated shape, a conical shape, a columnar shape and a cylindrical shape can be also adopted. The shaped article is used as an accessory such as a necklace, a pendant and a ring, a decoration for the accessory and an ornament, for example.

The shaped articles 10, 20 shown in FIGS. 1A, 1B, 2A and 2B are formed of a colorless transparent or a colored transparent materials such as borosilicate glass, quartz glass, soda glass, resin and plastic. When the above described materials are shaped by burning, the front surface, the reverse surface and the side surface of the shaped articles 10, 20 are inseparably and integrally formed. When housing the housed object such as a noble metal, a precious stone, a jewel or an imitation of them inside the shaped articles 10, 20, the shaped articles 10, 20 and the housed object are inseparably and integrally formed by mixing the housing object with the colorless transparent or colored transparent materials and then burning them together.

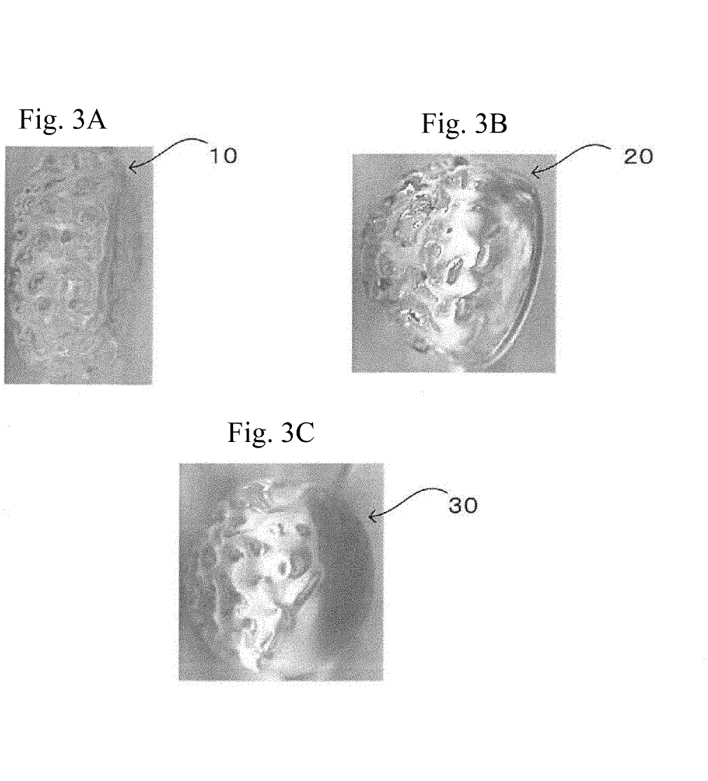

The front surface of the shaped articles 10, 20 has a smooth touch feeling, and the front surface has a smooth shape which is smoothly formed. Thus, the light can be easily entered. Since the front surface is colorless transparent or colored transparent, a pattern of the reverse surface can be seen through the front surface. Thus, when the precious stone or the like is housed inside, the precious stone or the like can be seen. Note that the smooth shape can be provided also on a part or an entire side surface or peripheral surface, in addition to the front surface. The position of the smooth shape is arbitrarily determined considering an amount of incident light and visibility of the precious stone or the like housed inside (shown in FIGS. 3A to 3C).

The smooth shape of the front surface and/or the peripheral surface can have any structure as long as the light can be easily entered. The smooth shape can be smooth as a whole, or can be smooth as a series such as a polyhedron having level differences.

The reverse surface of the shaped articles 10, 20 has a rough touch feeling, and the reverse surface has an uneven shape (recess) which is unevenly (raggedly) formed. Thus, the light entered from the smooth shape is easily dispersed and reflected. The above described uneven shape is a plurality of recesses shaped by burning. The uneven shape has numerous unevenness (ruggedness). Although the material of the reverse surface is also a colorless transparent or a colored transparent, the reverse surface is visually frosted by the numerous unevenness. Because of this, it is difficult to see the front surface from the reverse surface. Note that the uneven shape can be provided also on a part or an entire side surface or peripheral surface, in addition to the reverse surface. The position of the uneven shape is arbitrarily determined considering an amount of incident light and other conditions (shown in FIGS. 3A to 3C).

FIGS. 3A to 3C are diagrams showing an example of a side surface or a peripheral surface of the shaped article. In FIG. 3A, the uneven shape is formed on the entire side surface or peripheral surface of the shaped article 10. In FIG. 3B, on the other hand, the uneven shape is formed substantially on the left half and the smooth shape is formed substantially on the right half of the side surface or the peripheral surface of the shaped article 20. In FIG. 3C, the uneven shape is formed substantially on the left half and the smooth shape is formed substantially on the right half of the shaped article 30 having a spherical shape. In FIGS. 3A to 3C, the left side indicates the reverse surface, and the right side indicates the front surface.

Depending on the difference in height of the recesses forming the uneven shape, an appearance of the uneven shape seen from the reverse surface is different from an appearance of the reverse surface seen from the front surface. Because of this, in order to visually recognize the recesses from the smooth shape part, significant unevenness should be formed.

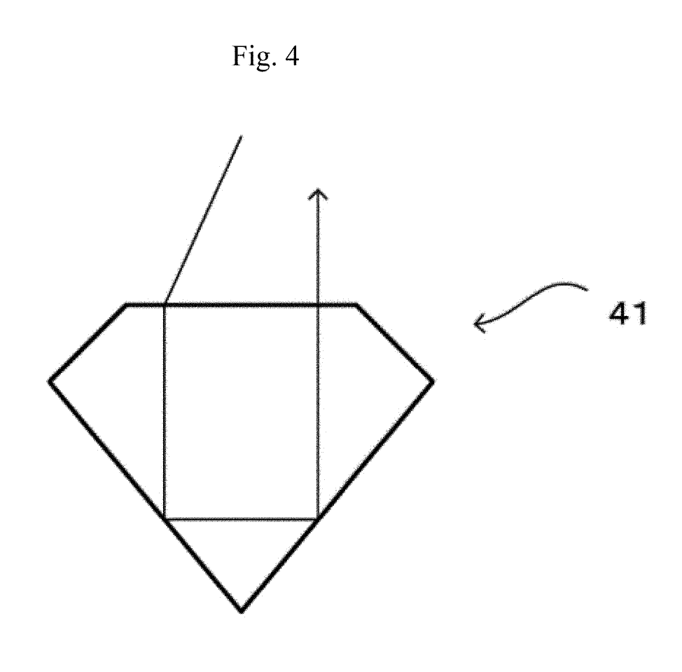

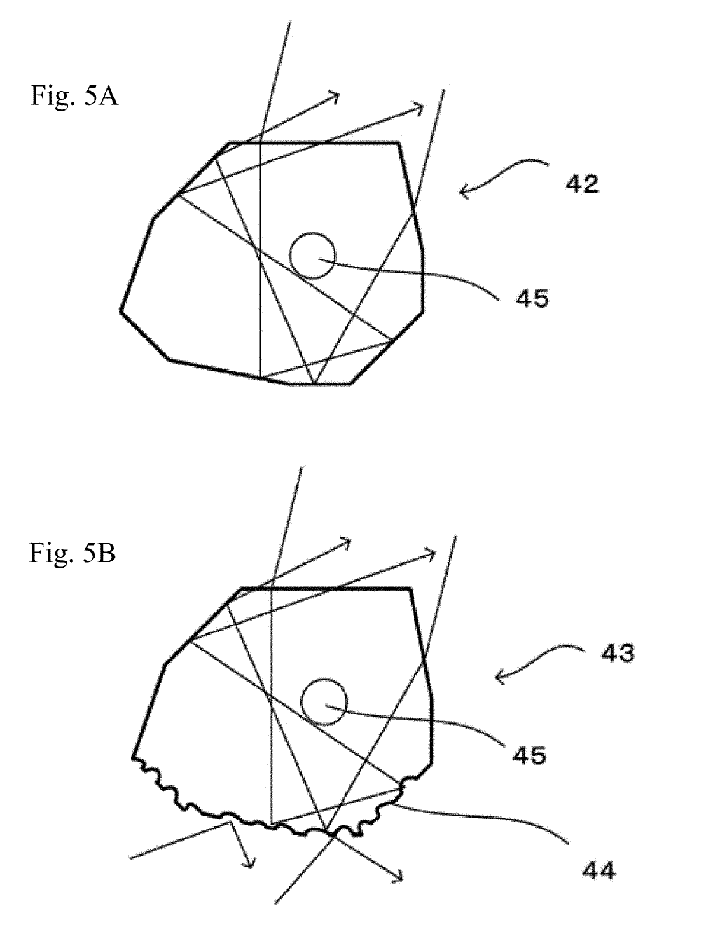

FIGS. 4, 5A and 5B are schematic diagrams showing a light path in the shaped articles 41, 42 and 43. FIG. 4 shows a diamond structure as an example of the shaped article 41. FIG. 5A shows a polyhedral structure as an example of the shaped article 42. FIG. 5B shows a polyhedral structure having recesses 44 as an example of the shaped article 43. As another example of the shaped article having the recesses 44, the shaped article having a plurality of dot-shaped recesses on an entire peripheral surface, the shaped article having the recesses with the curve pattern on an entire peripheral surface, and various kinds of shaped articles can be used.

In the case of the shaped article 41 shown in FIG. 4, the light entered from a certain direction is refracted and reflected repeatedly in the shaped article, and then radiated (emitted) outside the shaped article. Thus, the light is seen by the viewer. Since the shaped article 41 has a regular symmetrical structure, the reflection is basically repeated in a regular manner. In the case of the diamond, the light is considered to be entered from a flat surface located at an upper part and radiated (emitted) to the upper part after being refracted and reflected repeatedly. Thus, the emitted light is basically assumed to be seen by the viewer.

In the case of the shaped article 42 shown in FIG. 5A, since the shaped article 42 has an irregular asymmetrical structure, the light entered from a certain direction is refracted in various directions according to the angle of the wall surface from which the light is entered, reflected in various directions according to the angle of the wall surface to which the light is reflected, and then radiated (emitted) outside the shaped article to be seen by a viewer. Since the light interference occurs variously by the refraction and reflection caused by the irregular structure, the viewer can see the color other than the original color of the colorless transparent material or the colored transparent material.

In the case of the shaped article 43 shown in FIG. 5B, since the shaped article 43 is a structure having the recesses 44, there are more reflection light than the transmission light at the recesses 44. Thus, the light is almost totally reflected. Accordingly, the incident light entered from the smooth shape is radiated (emitted) outside the shaped article to be seen by the viewer. Thus, the part having the recesses 44 is relatively shadowed.

In FIG. 5, when a housed object 45 is housed in an approximately center of the shaped articles 42, 43, the light refracted and reflected in various directions in the shaped article is also irradiated to the housed object 45 from various angles. Thus, brightness of the housed object 45 can be seen by the viewer without depending on the position of the light source. In particular, in the case of the shaped article 43 having the recesses 44, the housed object 45 is visually complemented by the shadowed part of the recesses 44 when seen from the viewer. Accordingly, a viewer's interest can be attracted to the housed object 45 even when the amount of light is less than the case of the shaped article 42.

When an opal is used as the housed object 45, the light is irradiated to the opal from various angles. Accordingly, play of color effect of the opal can be extracted to the maximum regardless of the position of the light source and even when the amount of light is small. The opal is a kind of the precious stone having an iridescent color to be changed depending on the viewing direction, i.e., having play of color effect without having a particular color. In the shaped articles 42, 43, the light is irradiated to the opal from various angles, the viewer can enjoy the play of color effect even by the limited light source such as a sunlight and an illumination light using electricity in the daily living environment, and without changing the viewing direction intentionally. In particular, the shaped article having a spherically agglomerated shape is preferred to irradiate more light to the opal located inside the shaped articles 42, 43.

Note that, this invention is not limited to the above-mentioned embodiments. Although it is to those skilled in the art, the following are disclosed as the one embodiment of this invention.

Mutually substitutable members, configurations, etc. disclosed in the embodiment can be used with their combination altered appropriately.

Although not disclosed in the embodiment, members, configurations, etc. that belong to the known technology and can be substituted with the members, the configurations, etc. disclosed in the embodiment can be appropriately substituted or are used by altering their combination.

Although not disclosed in the embodiment, members, configurations, etc. that those skilled in the art can consider as substitutions of the members, the configurations, etc. disclosed in the embodiment are substituted with the above mentioned appropriately or are used by altering its combination.

While the invention has been particularly shown and described with respect to preferred embodiments thereof, it should be understood by those skilled in the art that the foregoing and other changes in form and detail may be made therein without departing from the sprit and scope of the invention as defined in the appended claims.

### INDUSTRIAL APPLICABILITY

The shaped article of the present invention is visually excellent, and useful for avoiding the risk of the bodily injury and the environmental disaster.

What is claimed is:

1. A shaped article inseparably and integrally formed of a colorless transparent material or a colored transparent material, wherein
a peripheral surface of the shaped article has an uneven shape,
the uneven shape is formed by a flat and irregular polyhedron, and
a housed object selected from the group consisting of: a noble metal; a precious stone; a jewel; an imitation of the noble metal, the precious stone or the jewel; and a combination of two or more of the noble metal, the precious stone, the jewel and the imitation is mixed with the colorless transparent material or the colored transparent material and burnt together to inseparably and integrally form the housed object housed in the shaped article.

2. A shaped article inseparably and integrally formed of a colorless transparent material or a colored transparent material, wherein
a peripheral surface of the shaped article has an uneven shape,
the uneven shape is formed by a plurality of recesses shaped by burning, and
a precious stone; a jewel; an imitation of the noble metal, the precious stone or the jewel; and a combination of two or more of the noble metal, the precious stone, the jewel and the imitation is mixed with the colorless transparent material or the colored transparent material and burnt together to inseparably and integrally form the housed object housed in the shaped article.

3. The shaped article according to claim 1, wherein
a front surface and a reverse surface of the shaped article are inseparably and integrally formed,
a smooth shape is formed on at least the front surface to make light incident, and
the uneven shape is formed on at least the reverse surface to disperse and reflect the light.

4. The shaped article according to claim 2, wherein
a front surface and a reverse surface of the shaped article are inseparably and integrally formed,
a smooth shape is formed on at least the front surface to make light incident, and
the uneven shape is formed on at least the reverse surface to disperse and reflect the light.
